(19) United States
(12) Patent Application Publication
(10) Pub. No.: US 2007/0011616 A1
(43) Pub. Date: Jan. 11, 2007

(54) User interface for dynamically managing presentations

(76) Inventors: Bas Ording, San Francisco, CA (US); Donald Dale Melton, San Carlos, CA (US)

Correspondence Address: James C. Scheller. Jr;BLAKELY, SOKOLOFF, TAYLOR & ZAFMAN LLP, Seventh Floor, 12400 Wilshire Boulevard, Los Angeles, CA, 90025-1026, US

(21) Appl. No.: 11/179,076

(22) Filed: Jul. 11, 2005

(51) Int. Cl. G06F 9/00

(52) U.S. Cl. 715/738; 715/811; 715/745; 715/739; 715/825

(57) ABSTRACT

Methods and systems for managing presentations to a user. In one exemplary method, presentations (e.g. a series of web pages) accessed by a user are monitored and at least some of these presentations are selected and organized (e.g. organized to reflect their relevance to the user). In another exemplary method, a presentation is marked as temporary and assigned an expiration date and removed at the expiration date. Other methods and various systems are also described.

### FIELD OF THE INVENTION

The present invention relates to methods, such as user interfaces, for dynamically managing document presentations or other types of presentations and, more particularly, relates to the automatic recording, organization, update and display of presentations based on user access patterns.

### BACKGROUND

The Internet is a global network of connected computer networks. Over the last several years, the Internet has grown significantly. A large number of computers on the Internet provide information in various forms. Anyone with a computer connected to the Internet can potentially tap into this vast pool of information. A typical user uses a browsing application (e.g., a browser) to access one or more Web pages provided by a Web server. A typical browser may be a version of Safari from Apple Corporation, Internet Explorer from Microsoft Corporation, or Netscape Communicator from Netscape Communications Corporation.

In a conventional user interface of a web browsing application, a user may find a previously visited page of interest by means of a History menu—which chronologically listing all the previous pages visited in the last few days—or via a Bookmarks or Favorites menu if the user had the foresight to explicitly store the page in such a retrievable menu.

In the case of the History menu, the user has to remember the title of the particular page in order to select it from the oftentimes cluttered menu. Alternatively, retrieving a page from Bookmarks or Favorites menu. Bookmark menus can also require more time than necessary since these menus tend to become cluttered with time as the user adds to the collection of pages and often lack structure. Conventional browsers allow the user to create hierarchical folders within which to organize and display the bookmarks, but this operation must be done by hand for every bookmark and can involve several steps.

A need exists, particularly as History and Bookmark lists become long, for a means of organizing and displaying presentations of interest to the user in a manner that quickly and clearly conveys the relative relevance of each page, and for a means of reducing unnecessary clutter in Bookmark lists, or other lists of recorded presentations.

### SUMMARY

The present invention describes methods for dynamically managing presentations that could be used, in one exemplary context, to augment the capabilities of the standard History and Bookmarks/Favorite menus available on most Internet browsers.

One particular embodiment of the invention involves a means for monitoring presentations accessed by the user, automatically selecting some of these presentations based on the user's access patterns, and organizing and displaying the selected pages to reflect their “rank” of relevance to the user, based on user access patterns (such as frequency of access) and/or attributes of the presentations (such as subject matter, metadata, origin, etc.). This feature can be used to present a more compact and prescient version of the History menu which, in its standard implementation, is merely a chronologically ordered archive of every single page accessed by the user in the past few days, without taking into account user access patterns of those pages.

A method for managing presentations in another exemplary embodiment of the invention includes monitoring user access patterns to presentations previously recorded as bookmarks or favorites in order to organize and display the bookmarked presentations (or a subset thereof) in a manner that reflects a rank of relevance to the user. The bookmarks are organized based on user access patterns and/or attributes of the bookmarks. Such a feature could be used to augment standard Bookmarks menus where bookmarks—unless specifically arranged by the user—are displayed in the order in which they were created, and would be particularly useful in cases where the bookmarks list is long, to allow the user to quickly pick out the bookmarks most likely to be of interest.

An additional embodiment of the invention involves a means to mark as temporary presentations recorded by the user as bookmarks or favorites, with an expiration date after which they are removed from the list. The bookmarks marked as temporary can either be removed automatically at the expiration date, or removed in response to a user command if the expiration date has been reached or exceeded. When a temporary bookmark is removed from the Bookmarks list it can be either deleted or stored in an archiving folder so it may still be found if needed. This feature can be used to augment the standard Bookmarks menus, which do not remove bookmarks unless explicitly deleted by the user one by one. Alternative removal criteria (other than expiration date) can be used, such as a presentation not having been accessed for a long time, a presentation no longer being accessible, or a specific triggering event. This functionality can be used to remove unnecessary clutter from Bookmarks menus.

In another aspect of the invention, an exemplary method of the invention allows a user to remove presentations from the bookmarks/favorite list whose links are “broken” or no longer operational”. An exemplary method involves attempting to access links in the bookmarks list and removing those that no longer work. This “clean up” of the Bookmarks/Favorite menu can be accomplished automatically (by, for example, performing the clean up once a day) or in response to a user command. When a broken link is removed from the Bookmarks list it can be either deleted or stored in an archiving folder so it may still be found if needed. This functionality can be used to further remove unnecessary clutter from Bookmarks menus.

### BRIEF DESCRIPTION OF THE DRAWINGS

The present invention is illustrated by way of example and not limitation in the figures of the accompanying drawings in which like references indicate similar elements.

FIG. 1 is a block diagram of a network of computer systems in which presentations, such as document presentations, may be accessed via a web browser.

FIG. 2 is a block diagram of a digital processing system which may be used to access a document presentation via a web browser.

FIG. 3 shows an exemplary bookmarks/favorite menu.

FIG. 4 shows an exemplary History menu in a browser.

FIG. 5 shows an exemplary History menu in a browser further containing a “Smart History” submenu. The Smart History menu is a possible embodiment of one aspect of the present invention.

FIG. 6 illustrates an alternate user interface in a browser for displaying the Smart History menu.

FIG. 7 is a flowchart illustrating the steps in an exemplary method of the invention. In one possible embodiment of the invention, this method relates to the Smart History menu.

FIG. 8 is a flowchart further breaking down the second step (determining which presentation s to add) of FIG. 7.

FIG. 9 is a flowchart further breaking down the third step of FIG. 7.

FIG. 10 is a flowchart showing an exemplary embodiment of FIG. 9.

FIG. 11 is a flowchart illustrating a further exemplary embodiment of FIG. 9.

FIG. 12 is a flowchart further breaking down the fourth step (display) of FIG. 7.

FIG. 13 is a flowchart illustrating an exemplary embodiment of FIG. 12, whereby the Smart History list is displayed as an ordered vertical list (e.g. the most relevant entry at the top and the least relevant at the bottom).

FIG. 14 shows a user interface illustrating the exemplary embodiment of the display step of FIG. 12, whereby the Smart History list is displayed as an ordered vertical list (e.g. the most relevant entry at the top and the least relevant at the bottom)

FIG. 15 is a flowchart illustrating another exemplary embodiment of FIG. 12, whereby the Smart History list is displayed as an vertical list with different indentations for each entry to indicate the relevance to the user of each entry (e.g. the most relevant entry is least indented)

FIG. 16 shows a user interface illustrating the exemplary embodiment of FIG. 15.

FIG. 17 is a flowchart illustrating another exemplary embodiment of FIG. 12, whereby the Smart History list is displayed such that font effects (e.g. bold font, underline, italics, flashing etc) indicate the relevance of each entry to the user.

FIG. 18 shows a user interface illustrating the exemplary embodiment of FIG. 17.

FIG. 19 is a flowchart illustrating another exemplary embodiment of FIG. 12, whereby the Smart History list is displayed such that font colors indicate the relevance of each entry

FIG. 20 is a flowchart illustrating another exemplary embodiment of FIG. 12, whereby the Smart History list is displayed such that font sizes indicate the relevance of each entry.

FIG. 21 shows a user interface illustrating the exemplary embodiment of FIG. 20.

FIG. 22 is a flowchart further breaking down the last step (update) of FIG. 7 and illustrating an exemplary embodiment.

FIG. 23 is a flowchart further breaking down the last step (update) of FIG. 7 and illustrating another exemplary embodiment.

FIG. 24 is a flowchart illustrating an aspect of the invention whereby, in an exemplary embodiment, the entries in a bookmarks or favorites list of a browser are automatically organized according to user access patterns.

FIG. 25 is a flowchart illustrating an aspect of the invention whereby, in an exemplary embodiment, the entries in a bookmarks or favorites list of a browser are organized according to user access patterns in response to a user request.

FIG. 26A shows a browser graphical user interface (GUI) with an exemplary Bookmarks menu further containing a click button to activate an additional “Dynamic Bookmarks” menu. The features contained in the Dynamic Bookmarks are a possible embodiment of some aspects of the present invention.

FIG. 26B shows the Dynamic Bookmarks displayed as a submenu of the Bookmarks menu, shown in response to the user clicking on the button marked “Dynamic Bookmarks” (as shown on FIG. 26A). In this particular example, the Dynamic Bookmarks menu show the bookmarked pages ordered by frequency of user access (with the most frequently accesses page at the top).

FIG. 27 shows an alternative browser GUI to activate the Dynamic Bookmarks menu. In this instance, a Dynamic Bookmarks item is included as part of the title bar in the browser, and activated in the standard fashion of a pull-down menu. As in FIG. 26B above, in this particular example, the Dynamic Bookmarks menu show the bookmarked pages ordered by frequency of user access.

FIG. 28A shows a submenu GUI for the Dynamic Bookmarks and with an alternative organization of the bookmarks. In this exemplary embodiment the bookmarked pages are ordered by recency of user access (with the most recently accessed bookmark page at the top).

FIG. 28B shows a title bar GUI for the Dynamic Bookmarks and with the same alternative organization of the bookmarked pages as in FIG. 28A. (bookmarked pages ordered by recency of use).

FIG. 29 is a flowchart illustrating the steps in an exemplary method of the invention, whereby bookmarked pages can be designated as temporary.

FIG. 30 is an exemplary embodiment of the method of FIG. 29 whereby a Dynamic Bookmarks menu contains two temporary bookmarks.

FIG. 31 is a flowchart illustrating the steps in an exemplary method of the invention, whereby broken links are automatically removed.

FIG. 32 is a flowchart illustrating the steps in an exemplary method of the invention, whereby broken links are removed in response to a user input.

FIG. 33A shows a GUI illustrating the method of FIG. 32, whereby a user can click on a button marked “Clean up” to remove all the bookmarks with broken links.

FIG. 33B shows the result of the “Clean up” operation requested by the user as illustrated in FIG. 33A, whereby two bookmarks with broken links have been removed.

### DETAILED DESCRIPTION

The subject of the invention will be described with reference to numerous details and accompanying drawings set forth below. The following description and drawings are illustrative of the invention and are not to be construed as limiting the invention. Numerous specific details are described to provide a thorough understanding of the present invention. However, in certain instances, well known or conventional details are not described in order to not unnecessarily obscure the present invention. It will be apparent to one skilled in the art that the present invention may be practiced without these specific details.

Throughout this description, the History and Bookmarks menus found on a generic computer-based Internet web browser will be used as exemplary contexts within which to illustrate the different aspects of the present invention. However, such contexts and technologies should not be construed as restricting the scope of the invention. Web browsers are graphical (visual) user interfaces that manage and display web pages (HTML documents). The present invention is not limited to web browsers, textual or visual presentations. The methods described in the following claims pertain to all manner of presentations, be they visual, audio, or of any other kind interpretable by the senses.

Exemplary embodiments of the present invention provide features which may be used to augment the capabilities of conventional History and Bookmarks/Favorites menus found in most Internet browsers. One aspect of the invention refers to the automatic recording of selected presentations accessed by the user and the ranking thereof based on user access patterns (for example, frequency of access to a given presentation). In an aspect of the invention, this feature could be used to reduce clutter in the History menu and improve the relevance of the pages stored therein, by allowing for the automatic recording of only selected presentations based on user patterns (such as, for example, frequency or recency of access). Furthermore, the organizing, update and display of these selected pages is performed in a manner that clearly communicates a hierarchy of relevance, or rank, to the user.

Other embodiments of the invention could be used to augment the capabilities of Bookmark menus. For example, the organization, update and display of bookmarked presentations in a manner that reflects a hierarchy of importance to the user. In another exemplary aspect of the invention, bookmarked pages can be further marked as temporary and deleted—either automatically or via user input—after a selected expiration dates accrues. Such a feature is useful for pages such as conference sites, online auctions, and other pages whose interest or content will become obsolete after some time and needlessly clutter bookmark lists. In yet another aspect of the invention, an exemplary embodiment would entail the capability to search for and remove any bookmarked pages with broken (non-functioning) links. Such a feature further reduces clutter in bookmark lists.

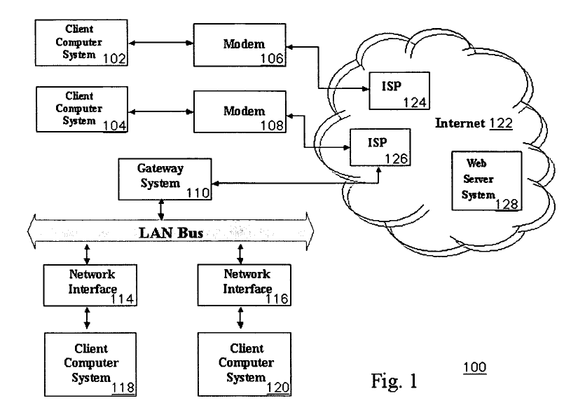

FIG. 1 is a diagram of a network computer system in which a web browser with History and Bookmark menus incorporating the methods of the invention may be used, according to one embodiment of the present invention. As shown in FIG. 1, a network 100 includes a number of client computer systems that are coupled together through an Internet 122. It will be appreciated that the term “Internet” refers to a network of networks. Such networks may use a variety of protocols for exchange of information, such as TCP/IP, ATM, SNA, SDI, etc. The physical connections of the Internet and the protocols and communication procedures of the Internet are well known to those in the art. It will be also appreciated that such system may be implemented in an Intranet within an organization.

Access to the Internet 122 is typically provided by Internet service providers (ISPs), such as the ISP 124, and the ISP 126. Users on client systems, such as the client computer systems 102, 104, 118, and 120, generally obtain access to the Internet through Internet service providers, such as ISPs 124 and 126. Access to the Internet may facilitate transfer of information (e.g., email, text files, media files, etc.) between two or more digital processing systems, such as the client computer systems 102, 104, 118, and 120 and/or a Web server system 128. For example, one or more of the client computer systems 102, 104, 118, and 120 and/or the Web server 128 may provide document presentations (e.g., a Web page) to another one or more of the client computer systems 102, 104, 118, and 120 and/or Web server 128. For example, in one embodiment of the invention, one or more client computer systems 102, 104, 118, and 120 may request to access a document that may be stored at a remote location, such as the Web server 128. In the case of remote storage, the data may be transferred as a file (e.g., download) and then displayed (e.g., in a window of a browser) after transferring the file. In another embodiment, the document presentation may be stored locally at the client computer systems 102, 104, 118, and/or 120. In the case of local storage, the client system may retrieve and display the document via an application, such as a word processing application. Without requiring a network connection.

The Web server 128 typically includes at least one computer system to operate with one or more data communication protocols, such as the protocols of the World Wide Web, and as such, is typically coupled to the Internet 122. Optionally, the Web server 128 may be part of an ISP which may provide access to the Internet and/or other network(s) for client computer systems. The client computer systems 102, 104, 118, and 120 may each, with appropriate Web browsing software, access data, such as HTML documents (e.g., Web pages), which may be provided by the Web server 128. The browsing software may include History Bookmark interfaces further incorporating the methods of the present invention in accordance with one embodiment of the invention, to allow a user to manage the recording, organizing and display of presentations in a manner that reflects their relevance to the user.

The ISP 124 provides Internet connectivity to the client computer system 102 via a modem interface 106, which may be considered as part of the client computer system 102. The client computer systems 102, 104, 118, and 120 may be a conventional data processing system, such as a Power Mac G4 or iMac computer available from Apple Computer, Inc., a “network” computer, a handheld/portable computer, a cell phone with data processing capabilities, a TV browser system, such as Web TV system, or other types of digital processing systems (e.g., a personal digital assistant (PDA)).

Similarly, the ISP 126 provides Internet connectivity for the client computer systems 102, 104, 118, and 120. However, as depicted in FIG. 1, such connectivity may vary between various client computer systems, such as the client computer systems 102, 104, 118, and 120. For example, as shown in FIG. 1, the client computer system 104 is coupled to the ISP 126 through a modem interface 108, while the client computer systems 118 and 120 are part of a local area network (LAN). The interfaces 106 and 108, shown as modems 106 and 108, respectively, may represent an analog modem, an ISDN modem, a DSL modem, a cable modem, a wireless interface, or other interface for coupling a digital processing system, such as a client computer system, to another digital processing system. The client computer systems 118 and 120 are coupled to a LAN bus 112 through network interfaces 114 and 116, respectively. The network interface 114 and 116 may be an Ethernet-type, asynchronous transfer mode (ATM), or other type of network interface. The LAN bus is also coupled to a gateway digital processing system 110, which may provide firewall and other Internet-related services for a LAN. The gateway digital processing system 110, in turn, is coupled to the ISP 126 to provide Internet connectivity to the client computer systems 118 and 120. The gateway digital processing system 110 may, for example, include a conventional server computer system. Similarly, the Web server 128 may, for example, include a conventional server computer system.

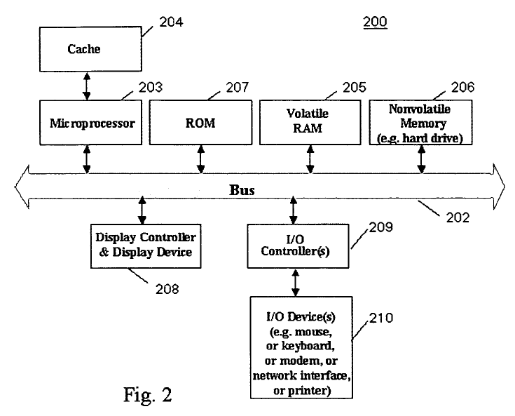

FIG. 2 is a block diagram of a digital processing system which may be used with one embodiment of the invention. For example, the system 200 shown in FIG. 2 may be used as a client computer system (e.g., the client computer systems 102, 104, 118, and/or 120), a Web server system (e.g., the Web server system 128), or a conventional server system, etc. Furthermore, the digital processing system 200 may be used to perform one or more functions of an Internet service provider, such as the ISP 124 and 126.

Note that while FIG. 2 illustrates various components of a computer system, it is not intended to represent any particular architecture or manner of interconnecting the components, as such details are not germane to the present invention. It will also be appreciated that network computers, handheld computers, cell phones, and other data processing systems which have fewer components or perhaps more components may also be used with the present invention. The computer system of FIG. 2 may, for example, be an Apple Macintosh computer.

As shown in FIG. 2, the computer system 200, which is a form of a data processing system, includes a bus 202 which is coupled to a microprocessor 203 and a ROM 207, a volatile RAM 205, and a non-volatile memory 206. The microprocessor 203, which may be a PowerPC G3, PowerPC G4 or PowerPC G5 microprocessor from Motorola, Inc. or IBM, is coupled to cache memory 204 as shown in the example of FIG. 2. The bus 202 interconnects these various components together and also interconnects these components 203, 207, 205, and 206 to a display controller and display device 208, as well as to input/output (I/O) devices 210, which may be mice, keyboards, modems, network interfaces, printers, and other devices which are well-known in the art. Typically, the input/output devices 210 are coupled to the system through input/output controllers 209. The volatile RAM 205 is typically implemented as dynamic RAM (DRAM) which requires power continuously in order to refresh or maintain the data in the memory. The non-volatile memory 206 is typically a magnetic hard drive, a magnetic optical drive, an optical drive, or a DVD RAM or other type of memory system which maintains data even after power is removed from the system. Typically the non-volatile memory will also be a random access memory, although this is not required. While FIG. 2 shows that the non-volatile memory is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface. The bus 202 may include one or more buses connected to each other through various bridges, controllers, and/or adapters, as is well-known in the art. In one embodiment, the I/O controller 209 includes a USB (Universal Serial Bus) adapter for controlling USB peripherals.

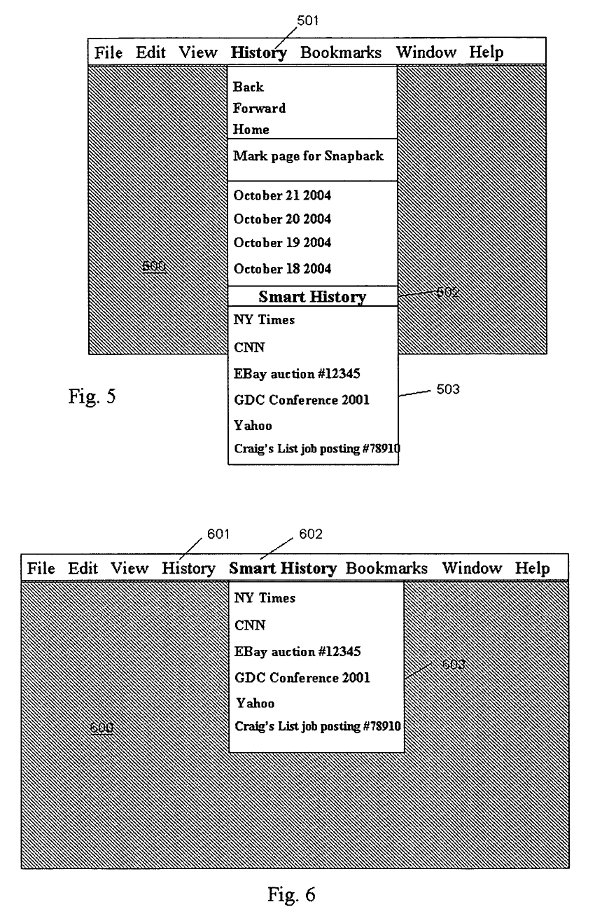

One aspect of the invention entails monitoring user-accessed presentations and then automatically selecting some of the accessed presentations based on user access criteria (for instance, frequency of use). Such a method could be used to both anticipate user preferences and to present a less cluttered list of relevant presentations to the user than, for example, the standard History menu in a web browser which instead records all user-accessed presentations in chronological order. In an exemplary embodiment of the aforementioned aspect of the invention, a “Smart History” menu option could be offered to the user as an addition to the standard History feature. Said Smart History menu is illustrated in FIG. 5 and FIG. 6 described below.

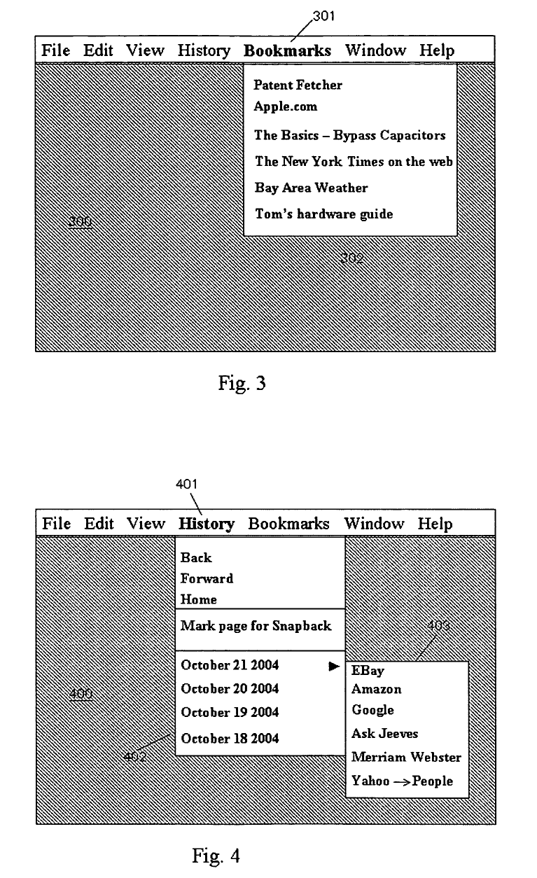

FIG. 3 shows a GUI 300 having a typical Bookmarks menu interface 301 which may be incorporated into a browser. The bookmark list 302 shown here will be used as a recurring example to help illustrate embodiments of the invention in later figures.

FIG. 4 shows a representative browser window 400 with a typical History pull down menu 402 & 403.

FIG. 5 and FIG. 6 show two possible browser GUIs for an exemplary Smart History menu. In FIG. 5 the Smart History menu 502 is a submenu of the History menu 501 on the tool bar. The list of web pages 503 that were selected for the Smart History are a select few that were previously accessed by the user and that fit a certain criteria of relevance (e.g. they were frequently or recently accessed). In contrast to the list of web pages that would be contained under the History menu, the Smart History list is shorter and more pertinent to the user.

FIG. 6 illustrates an alternate browser GUI for displaying the Smart History menu, whereby the Smart History menu 603 has its own entry in the tool bar 602, alongside the standard History menu 601.

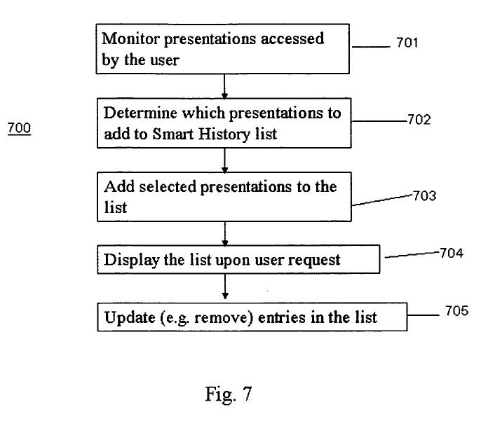

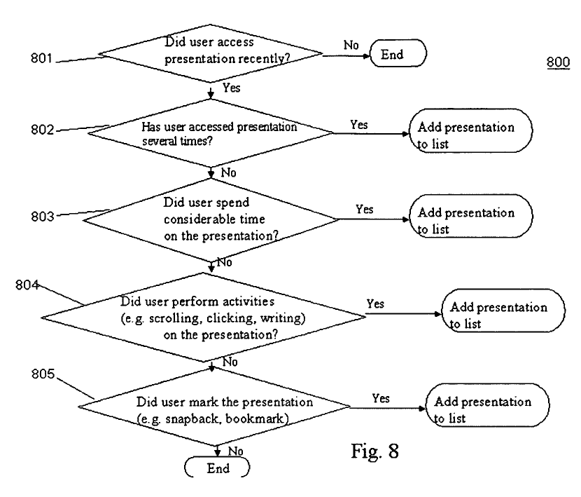

FIG. 7 is a flow chart illustrating the steps involved in the foregoing aspect of the invention, whereby, in one possible embodiment of the invention, the Smart History menu is used to exemplify said aspect of the invention. The first step in the method 701 involves monitoring presentations accessed by the user. The second step 702 involves determining which of those presentations are important to the user based on his/her access patterns. The goal is to keep a list of presentations that the user is likely to want to access again in the near future. In the third step 703, those selected presentations are added to a list with an internal organization that reflects their relevance rank to the user. The presentations may be organized based on user access patterns (such as frequency of use) and attributes of the presentations (such as subject matter, metadata, origin, etc). The fourth step 704 involves the display of the organized list to the user in a manner that reflects the relevance rank of each entry in the list. The last step 705 updates the list (for example, by removing entries) as the user accesses new pages, or the user's access patterns change. The following FIGS. 8-22 offer, in turn, additional details and illustrations of each of the five steps of FIG. 7.

FIG. 8 is a flowchart further breaking down the second step 702 of FIG. 7. In order to determine which user-accessed presentations to add to the list, any number of criteria based on user access patterns may be employed. For instance, FIG. 8 illustrates one exemplary sequence of criteria that may be used to determine if a presentation should be selected as relevant to the user. In this particular example, the criteria for adding a page to the list are recency of access to the page and either of: frequent access to the page, spending considerable time on the page, performing a number of activities on the page, or having previously marked the page (an example of methods to refer back to previously visited presentations is described in co-pending U.S. patent application Ser. No. 10/337,768 filed on Jan. 6, 2003 by inventors Scott Forestall, Donald Dale Melton and John William Sullivan and entitled “User Interface for Accessing Presentations”).

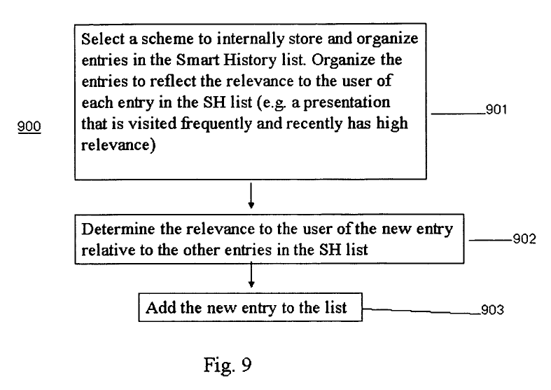

FIG. 9 is a flowchart further breaking down the third step 703 of FIG. 7. which involves adding an entry to the list. The first step 901 involves selecting a scheme to internally store and organize entries. The organization reflects the relevance of each entry to the user. For example, the organization chosen could be an ordered list with the most frequently visited presentation at the top. Alternatively, the organization chosen could be a stack, queue or hash table. The presentations may be organized based on user access patterns (such as frequency of use) and attributes of the presentations (such as subject matter, metadata, origin, etc). Once the organizing scheme has been chosen, each entry's relevance relative to the other entries is determined and the location of each entry within the organization is determined (this corresponds the second step 902 on the flowchart). When a new entry is added, it is similarly positioned in its correct location within the organized list of existing entries (third step 903). In other cases, entries may be organized in groups, folders or sets (for example, entries are grouped by subject matter) and not as a flat list. In yet other cases, entries may be organized in groups, and then as lists within each group, with location in the internal list indicating rank of relevance.

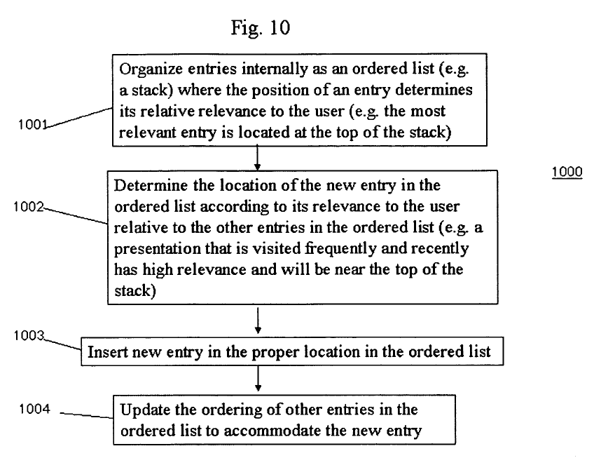

FIG. 10 and FIG. 11 are flowcharts showing exemplary embodiments of FIG. 9. In particular, FIG. 10 shows an example of an organizing scheme wherein entries in the Bookmarks list are ordered in a list (such a stack, queue etc) where the position in the list corresponds to the entry's relevance rank relative to the other entries. In such a scheme, a new entry must be positioned in the right location within the list 1002 & 1003 and the existing entries reordered to accommodate the new entry 1004. Alternatively, FIG. 11 depicts a scheme where the entries are not ordered into a structure (such as a list) but each entry is given a number 1101 to reflect its relevance rank (for example, the most relevant entry is assigned number 1). Addition of a new entry would require first determining its relative relevance 1102 and assigning it a corresponding number 1103, then re-assigning numbers to the other existing entries to accommodate the new entry 1104 and finally adding the new entry to the list 1105. Other hierarchical organizing schemes can be adopted, such as grouping entries based on their attributes.

FIG. 12 describes in more detail, via a flowchart, the display step of FIG. 7 704, breaking it down into: selecting a visual method to display the Smart History list in a manner that clearly communicate the relevance of each entry to the user 1201; receiving user input to display the list 1202; and displaying the list according to the chosen method 1203. Alternatively, in other embodiments, the visual method used to build and display the list is selected after the user input to display the list is received. In yet another embodiment, the entries in the Smart History list may be displayed as thumbnails or displayed as part of folders if, for example, they were organized by some attribute of the entries, such as subject matter, metadata or origin.

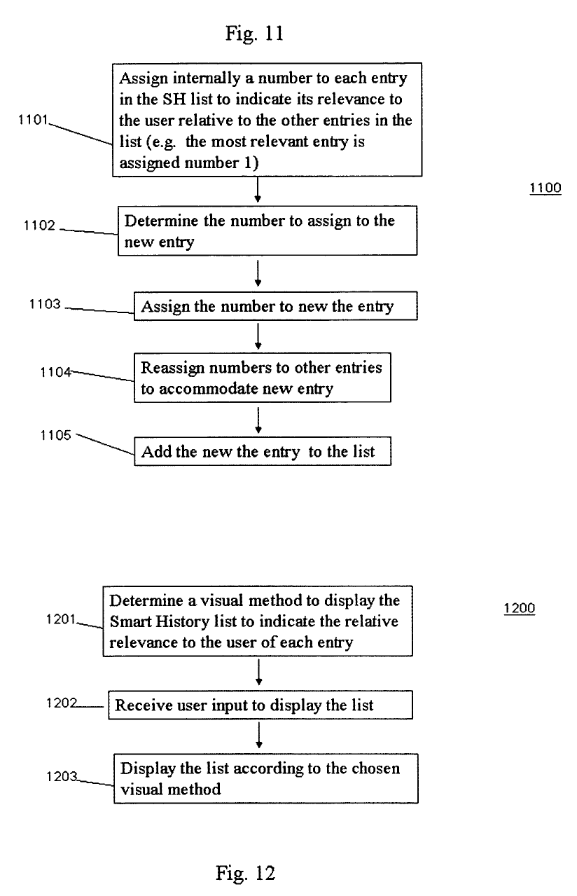

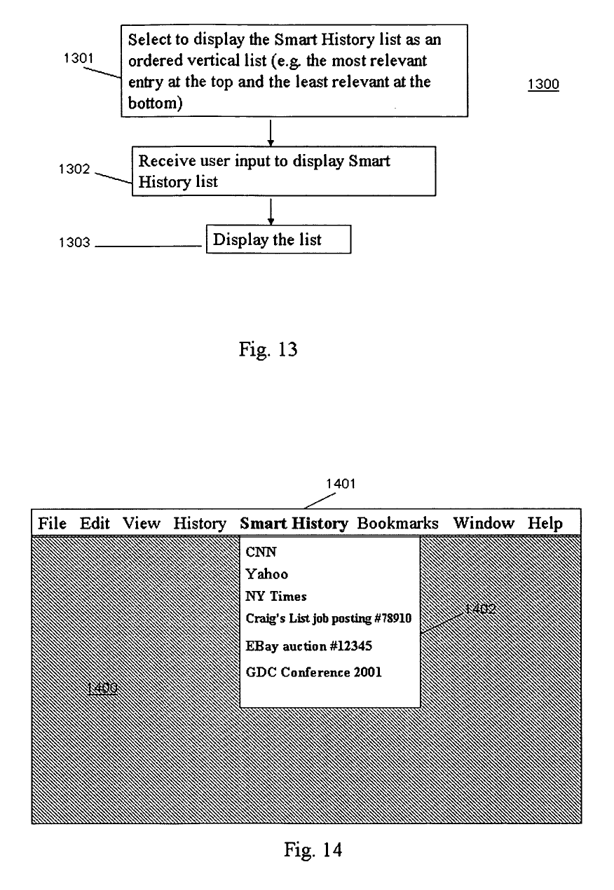

FIGS. 13-21 show exemplary embodiments, via flowcharts and GUI drawings, of FIG. 12. Specifically, FIG. 13 is a flowchart illustrating an exemplary embodiment of FIG. 12, whereby the Smart History list is displayed as an ordered vertical list 1301 (e.g. the most relevant entry at the top and the least relevant at the bottom). Alternatively, in other embodiments, the visual method used to build and display the list is selected after the user input to display the list is received. In yet another embodiment, the entries in the Smart History list may be displayed as thumbnails. FIG. 14 is an accompanying figure showing a user interface illustrating the exemplary embodiment of FIG. 13. The Smart History menu 1401 is displayed as an ordered vertical list 1402 with the most relevant entry at the top and the least relevant at the bottom.

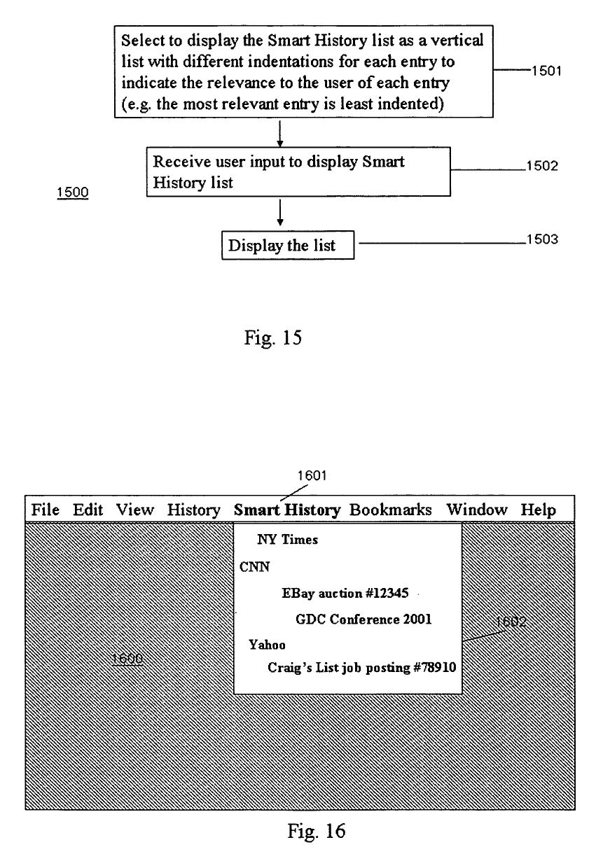

FIG. 15 is a flowchart illustrating another exemplary embodiment of FIG. 12, whereby the Smart History list is displayed as a vertical list with different indentations for each entry to indicate the relevance to the user of each entry (e.g. the most relevant entry is least indented) 1501. FIG. 16 is an accompanying figure showing a user interface illustrating the exemplary embodiment of FIG. 15. The Smart History menu 1601 is displayed as a series of entries with different indentations 1602 to indicate each entry's relevance.

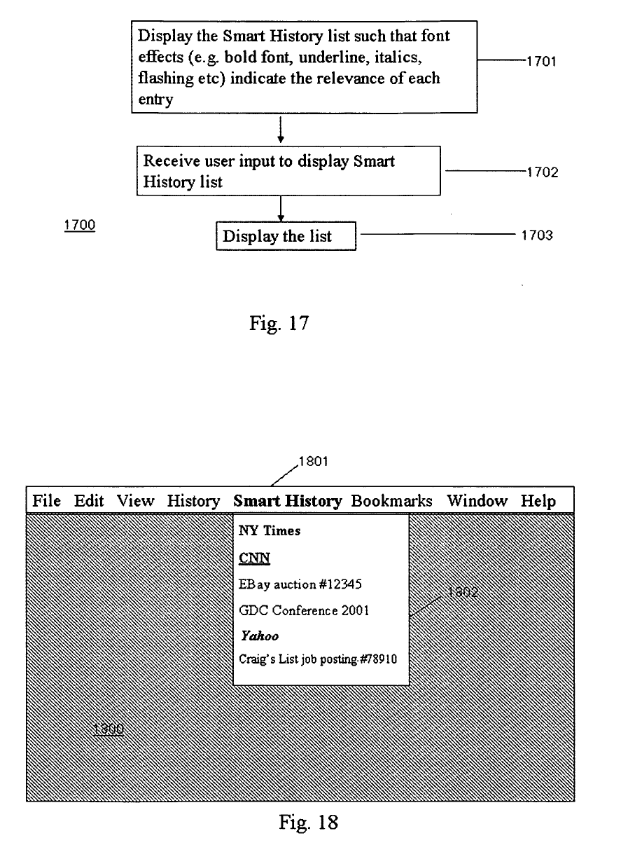

FIG. 17 is a flowchart illustrating one more possible exemplary embodiment of FIG. 12, whereby the entries in the Smart History list are displayed with different font effects (e.g. bold font, underline, italics, flashing etc) to indicate the relevance of each entry to the user. FIG. 18 is an accompanying figure showing a user interface illustrating the exemplary embodiment of FIG. 17. The entries in the Smart History menu 1801 are shown in underlines, bold, italic, etc 1802 to indicate each entry's relevance.

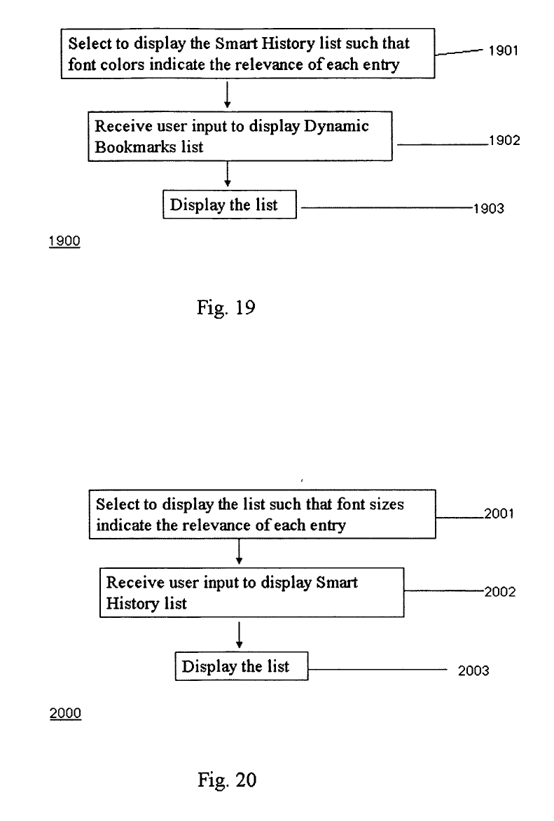

FIG. 19 is a flowchart illustrating an additional exemplary embodiment of FIG. 12, whereby the entries in the Smart History list are displayed with different font colors 1901 to indicate the relevance of each entry to the user.

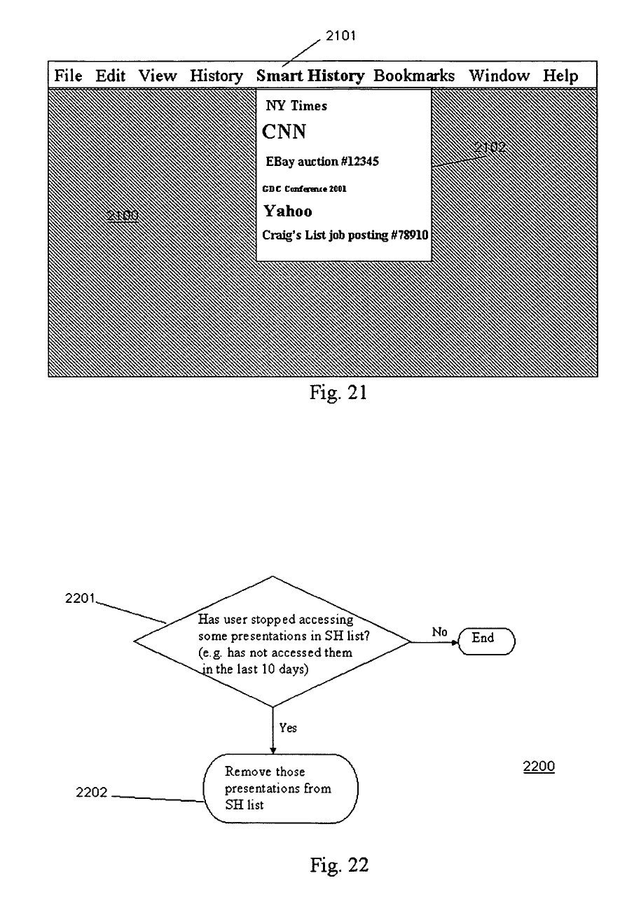

FIG. 20 is a flowchart illustrating yet another exemplary embodiment of FIG. 12, whereby the entries Smart History list are displayed with different font sizes 2001 to indicate the relevance of each entry to the user. FIG. 21 is an accompanying figure showing a user interface illustrating the exemplary embodiment of FIG. 20. The Smart History menu 2101 is displayed as a list 21202 where the bigger font size of an entry, the higher its relevance to the user.

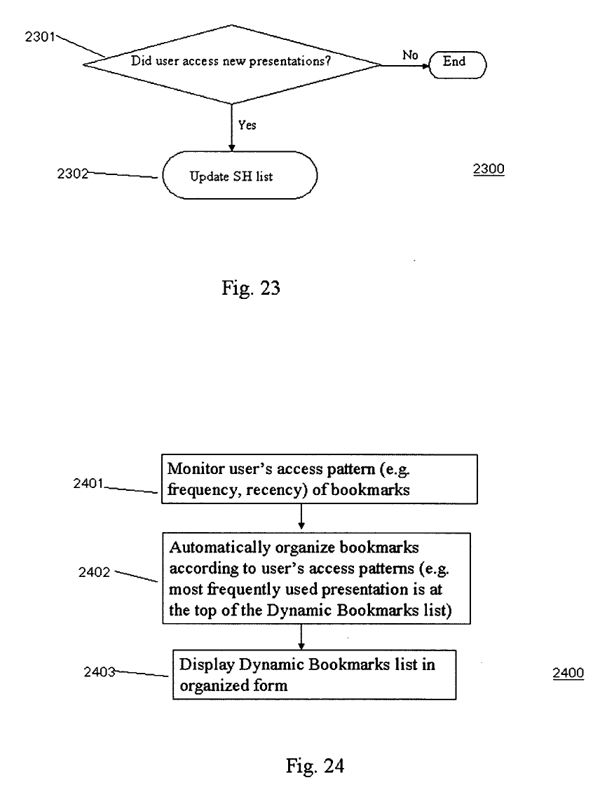

FIG. 22 and FIG. 23 are flowcharts further breaking down the last step 705 of FIG. 7, which pertains to updating the presentations stored in the list. The automatically created list of relevant presentations can be updated in a number of ways. For instance, FIG. 22 shows an exemplary embodiment of the update procedure, whereby presentations that have not been accessed in a given number of days 2201 are removed from the list 2202.

FIG. 23 presents another possible embodiment of the update procedure, whereby the list is updated 2302 whenever a new presentation has been accessed by the user 2301.

Another exemplary embodiment of the invention includes monitoring user access patterns to presentations previously recorded as bookmarks or favorites in order to organize and display the bookmarked presentations in a manner that reflects a rank of relevance to the user. The entire bookmarks list can be organized and displayed, or alternatively, a reduced set of bookmarks containing those bookmarks deemed most relevant to the user. Such a feature could be used to augment standard Bookmarks, menus where bookmarks—unless specifically arranged by the user—are displayed in the order in which they were created, and would be particularly useful in cases where the bookmarks list is long, allowing the user to quickly pick out the bookmarks most likely to be of interest.

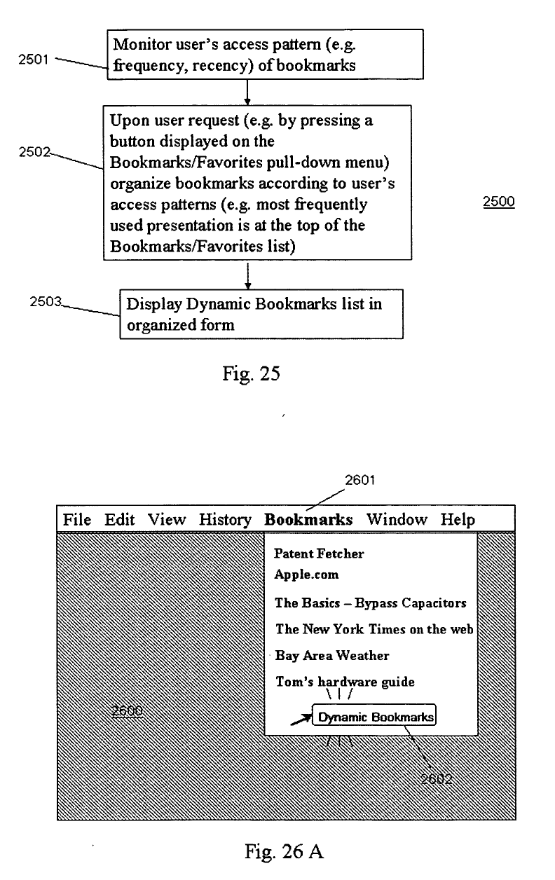

FIG. 24 is a flowchart illustrating an aspect of the invention whereby, in an exemplary embodiment, the entries in a bookmarks or favorites list of a browser are monitored for user access 2401 and automatically organized according to user access patterns 2402 (for example, the most frequently accessed bookmark is displayed at the top of the list). The presentations could further be organized based on attributes of the presentations, such as subject matter or metadata. FIG. 25 is a similar flowchart illustrating the same aspect of the invention but whereby the bookmarks are organized and displayed only in response to a user request 2502.

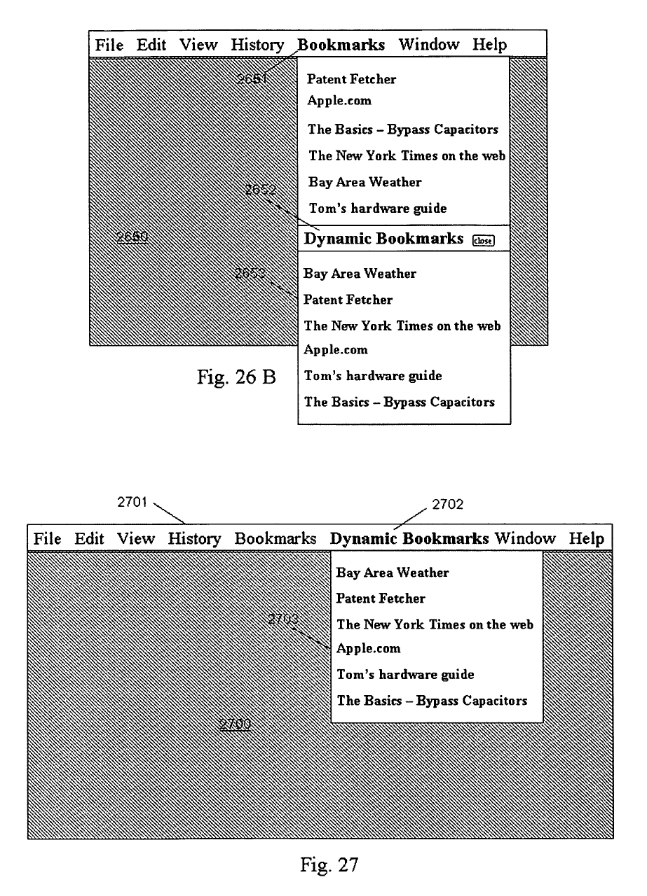

In an exemplary embodiment of the presently discussed aspect of the invention, a “Dynamic Bookmarks” menu could be offered to the user as an addition to the standard Bookmarks menu. FIG. 26A shows a graphical user interface (GUI) with an exemplary Bookmarks menu 2601 further containing a click button 2602 to activate an additional “Dynamic Bookmarks” menu. The Dynamic Bookmarks menu may contain additional features that are possible embodiments of additional aspects of the present invention, as will be discussed shortly.

FIG. 26B shows the Dynamic Bookmarks 2652 displayed as a submenu of the Bookmarks menu 2651, shown in response to the user clicking on the button marked “Dynamic Bookmarks” (as shown on FIG. 26A 2602). In this particular example, the Dynamic Bookmarks menu 2652 show the bookmarked pages ordered by frequency of user access (with the most frequently accesses page at the top) 2653.

FIG. 27 shows an alternative browser GUI to activate the Dynamic Bookmarks menu. In this instance, a Dynamic Bookmarks heading 2702 is included as part of the title bar in the browser 2701, and activated in the standard fashion of a pull-down menu 2703. As in FIG. 26B above, in this particular example, the Dynamic Bookmarks menu shows the bookmarked pages ordered by frequency of user access 2703.

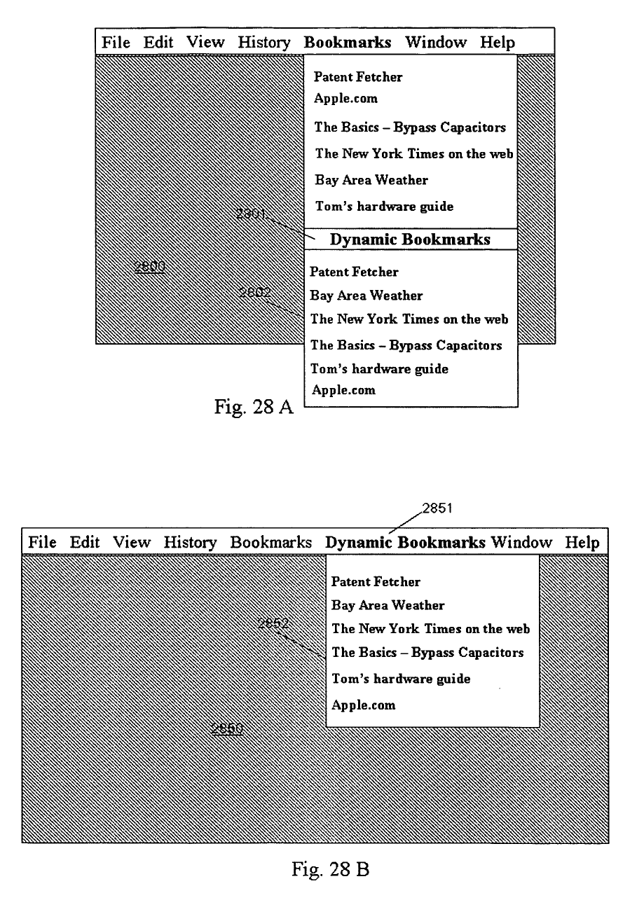

FIG. 28A shows a submenu GUI for the Dynamic Bookmarks 2801 and with an alternative organization of the bookmarks. In this exemplary embodiment, the bookmarked pages are ordered by recency of user access (with the most recently accessed bookmark page at the top) 2802.

FIG. 28B shows a title bar GUI for the Dynamic Bookmarks 2851 and with the same alternative organization of the bookmarked pages as in FIG. 28A. (bookmarked pages ordered by recency of use) 2852.

An additional embodiment of the invention involves a means to mark as temporary presentations recorded by the user as bookmarks or favorites, with an expiration date after which they are removed from the list. The bookmarks marked as temporary can either be removed automatically at the expiration date, or removed in response to a user command if the expiration date has been reached or exceeded. Alternative removal criteria (other than expiration date) can be used, such as a presentation not having been accessed for a long time, a presentation no longer being accessible, or a specific triggering event. When temporary bookmarks are removed from the Bookmarks list they can be either deleted or stored in an archiving folder so they may still be found if needed. This feature can be used to augment the standard Bookmarks menus, which do not remove bookmarks unless explicitly deleted by the user one by one. A Dynamic Bookmarks menu may contain said additional feature as a possible embodiment of an aspect of the present invention.

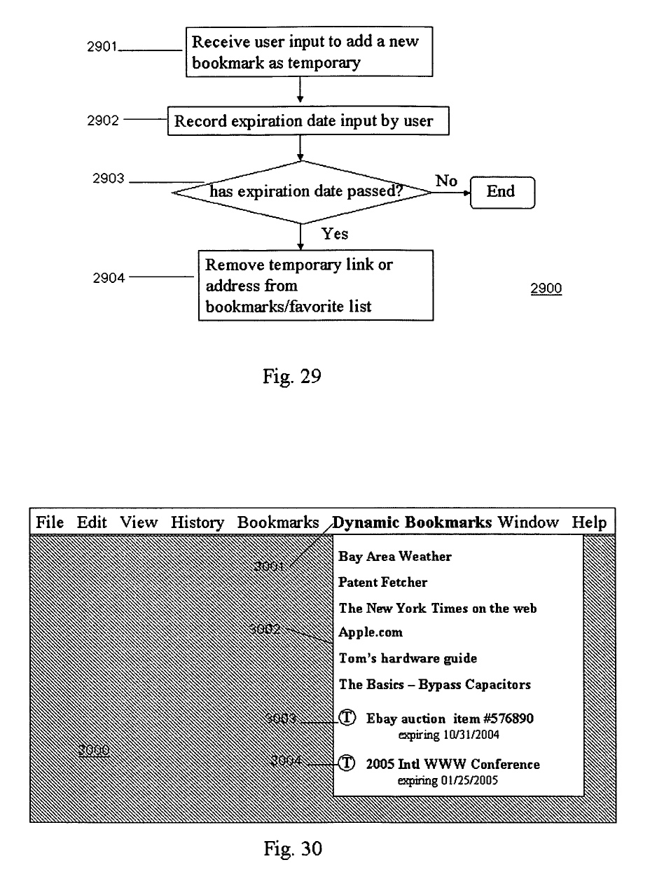

FIG. 29 is a flowchart illustrating the steps in an exemplary method whereby bookmarked pages can be designated as temporary. After receiving input from the user to mark a recorded presentation, or a bookmark, as temporary 2901, the user must also input the expiration date 2902 after which the pages will be removed from the bookmarks list 2904. Similarly, the user can also mark already existing bookmarks as temporary, with an associated expiration date.

FIG. 30 shows a browser GUI containing a Dynamic Bookmarks menu 3001 to illustrate an exemplary embodiment of the method of FIG. 29. In this example, the Dynamic Bookmarks list 3002 contains two temporary bookmarks 3003 and 3004.

In another aspect of the invention, an exemplary method allows a user to remove presentations from the bookmarks/favorite list whose links are “broken” or no longer operational. The method involves attempting to access links in the bookmarks list and removing those that no longer work. This “clean-up” of the bookmarks/favorite list can be accomplished automatically (by, for example, performing the clean up once a day) or in response to a user command. When broken links are removed from the Bookmarks list they can be either deleted or stored in an archiving folder so they may still be found if needed. This functionality can be used to remove unnecessary clutter from Bookmarks menus.

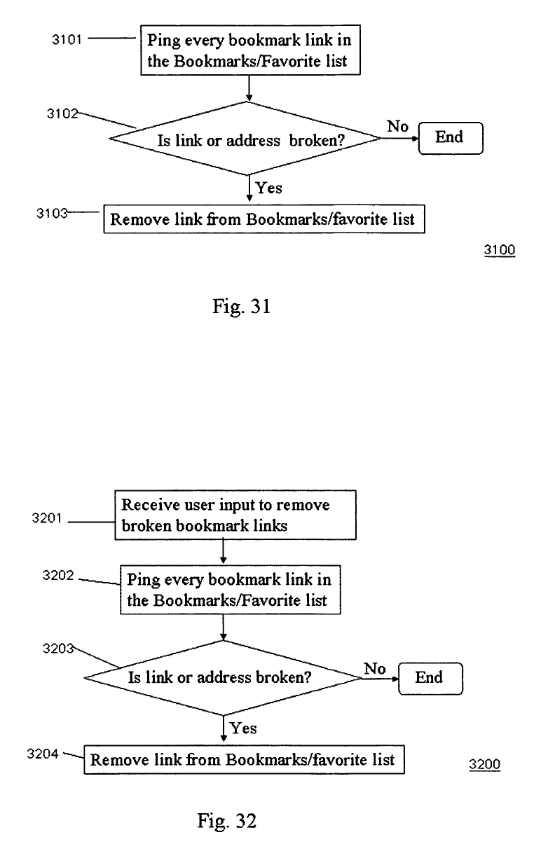

FIG. 31 is a flowchart illustrating the steps in an exemplary method of the aforementioned aspect of the invention, whereby, automatically, the links to every bookmark in the list are pinged 3101 and any broken links are removed 3102 and 3103.

FIG. 32 is a flowchart illustrating a similar method to that of FIG. 31, but where bookmarks are pinged 3202 and broken links removed 3204 in response to a user input 3201.

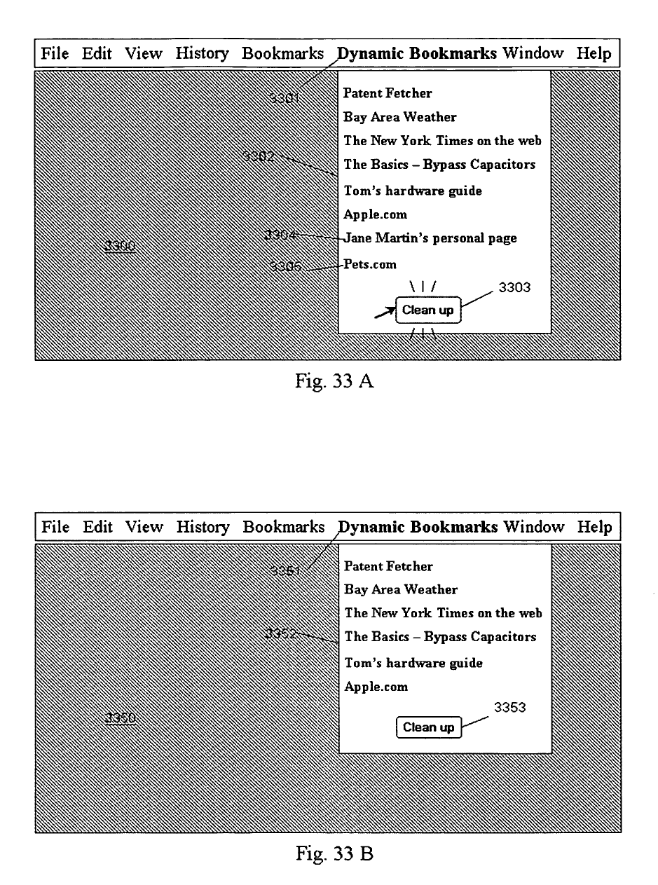

FIG. 33A shows a browser GUI illustrating the method of FIG. 32, whereby a user can click on a button marked “Clean up” 3303 to remove any bookmarks with broken links in the Bookmarks menu 3302.

FIG. 33B is an accompanying figure showing the result of the “Clean up” operation requested by the user as illustrated in FIG. 33A 3303, whereby two bookmarks with broken links (3304 and 3305 of FIG. 33A) have been removed (this is apparent by comparing the bookmarks list 3302 of FIG. 33A with the bookmarks list 3352 of FIG. 33B).

In the foregoing specification, the invention has been described with reference to specific exemplary embodiments thereof. It will be evident that various modifications may be made thereto without departing from the broader spirit and scope of the invention as set forth in the following claims. The specifications and drawings are, accordingly, to be regarded in an illustrative sense rather than a restrictive sense.

What is claimed is:

1. A machine readable medium providing instructions which when executed by a system cause the system to perform a method comprising:
monitoring presentations accessed by a user;
automatically selecting some of the presentations accessed by the user according to the user's access patterns; and
organizing the selected presentations to reflect their relevance to the user.

2. The medium of claim 1, wherein a presentation is automatically selected according to the user's access patterns comprising at least one of:
frequency of user's access;
recency of user's access;
amount of time spent by the user on the presentation;
amount of user activity performed on the presentation;
recording by the user of the presentation in a favorite list; and
marking of the presentation for later access by the user.

3. The medium of claim 1, wherein the selected presentations are organized comprising at least one of:
ordering the positions of each selected presentation in a list to reflect the relative relevance of each presentation in the list to the user;
assigning a number to each selected presentation to reflect the relative relevance of each presentation to the user;
organizing the selected presentations in a hierarchical structure; and
organizing the selected presentations in a non-hierarchical structure.

4. The medium of claim 1, wherein the selected presentations are organized based on at last one of user access patterns and attributes of the presentations.

5. The medium of claim 1, wherein selecting and organizing the presentations are automatically updated as the user's access patterns change.

6. The medium of claim 5, further comprising removing presentations that are no longer considered relevant to the user.

7. The medium of claim 1, wherein in response to a user input, the organized presentations are displayed to reflect their organization, comprising at least one of:
displaying the selected presentations as an ordered list with the most relevant presentation at one end of the list and the least relevant at the other to reflect the relative relevance to the user of each presentation;
displaying the selected presentations as a vertical list where entries have different indentations to reflect the relative relevance to the user of each presentation;
displaying the selected presentations with different font effects to reflect the relative relevance to the user of each presentation;
displaying the selected presentation with at least one of different icons and other graphic representations to reflect the relative relevance to the user of each presentation; and
displaying the selected presentations in at least one of groups, inside folders and other graphic containers to reflect a nested organization.

8. The medium of claim 1, wherein the presentations may be at least one of visual presentations, web pages, audio presentations, tactile presentations, and any other type of presentations.

9. A machine readable medium containing instructions that when executed cause a system to perform a method of managing data, the method comprising:
monitoring presentations previously recorded by a user for later access;
automatically selecting some of the user-recorded presentations accessed by the user according to the user's access patterns; and
organizing the selected presentations to reflect their relevance to the user.

10. A machine readable medium containing instructions that when executed cause a system to perform a method of managing data, the method comprising:
monitoring a user's access patterns of presentations recorded by the user as bookmarked presentations; and
organizing the bookmarked presentations according to the user's access patterns of bookmarked presentations.

11. The medium of claim 10, wherein a presentation is automatically selected according to the user's access patterns comprising at least one of:
frequency of user's access;
recency of user's access;
amount of time spent by the user on the presentation;
amount of user activity performed on the presentation;
recording by the user of the presentation in a favorite list; and
marking of the presentation for Snapback by the user.

12. The medium of claim 10, wherein the selected presentations are organized comprising at least one of:
ordering the positions of each selected presentation in a list to reflect the relative relevance of each presentation in the list to the user;
organizing the selected presentations in a hierarchical structure; and
organizing the selected presentations in a non-hierarchical structure.

13. The medium of claim 10, wherein selecting presentations and organizing the selected presentations are automatically updated as the user's access patterns change.

14. The medium of claim 10, further comprising removing presentations that are no longer considered relevant to the user.

15. The medium of claim 10, wherein in response to a user input, the organized presentations are displayed to reflect their organization, comprising at least one of:
displaying the selected presentations as a vertical list where entries have different indentations to reflect the relative relevance to the user of each presentation;
displaying the selected presentations with different font effects to reflect the relative relevance to the user of each presentation;
displaying the selected presentation with at least one of different icons and other graphic representations to reflect the relative relevance to the user of each presentation; and
displaying the selected presentations in at least one of groups, inside folders and other graphic containers to reflect a nested organization.

16. The medium of claim 10, wherein the presentations may be at least one of visual presentations, web pages, audio presentations, tactile presentations, and any other type of presentations.

17. A machine readable medium containing instructions that when executed cause a system to perform a method of managing data, the method comprising:
marking a recorded presentation as temporary;
assigning an expiration date to the presentation; and
removing the presentation at the expiration date.

18. A machine readable medium containing instructions that when executed cause a system to perform a method of managing data, the method comprising:
marking a recorded presentation as temporary;
specifying removal criteria for the presentation; and
removing the presentation when the removal criteria are met.

19. A medium as in claim 18 wherein the removal criteria for the presentation comprise at least one of:
reaching a specific expiration date;
the presentation no longer being accessible;
the presentation not having been accessed for a given amount of time; and
a triggering event.

20. A medium as in claim 18 wherein marking the presentation is performed in response to a user input.

21. The medium of claim 18, wherein removing the presentation is performed automatically.

22. The medium of claim 18, wherein the presentation may be at least one of a visual presentation, web page, audio presentation, tactile presentation, and any other type of presentation.

23. A machine readable medium containing instructions that when executed cause a system to perform a method of managing data, the method comprising:
attempting to access a presentation recorded by a user;
presenting the user with the option to remove the presentation if the presentation can no longer be accessed; and
removing the presentation if the user elects to remove the presentation.

24. A medium as in claim 23 wherein attempting to access the presentation is performed in response to an input by the user.

25. A medium as in claim 23 wherein attempting to access the presentation is performed automatically.

26. A medium as in claim 23 wherein the recorded presentation is part of a favorites list.

27. A machine readable medium containing instructions that when executed cause a system to perform a method of managing data, the method comprising:
attempting to access all presentations in a list; and
removing presentations from the list that can no longer be accessed.

28. The medium of claim 27, wherein removing presentations from the list that can no longer be accessed is performed automatically.

29. The medium of claim 27, wherein removing presentations from the list is performed in response to a user input.

30. The medium of claim 27, wherein the list is a favorites list.

31. The medium of claim 27, wherein the presentations may be at least one of visual presentations, web pages, audio presentations, tactile presentations, and any other type of presentations.

32. A method of managing data, the method comprising:
monitoring presentations accessed by a user;
automatically selecting some of the presentations accessed by the user according to the user's access patterns; and
organizing the selected presentations to reflect their relevance to the user.

33. The method of claim 32, wherein a presentation is automatically selected according to the user's access patterns comprising at least one of:
frequency of user's access;
recency of user's access;
amount of time spent by the user on the presentation;
amount of user activity performed on the presentation;
recording by the user of the presentation in a favorite list; and
marking of the presentation for later access by the user.

34. The medium of claim 32, wherein the selected presentations are organized based on at least one of user access patterns and attributes of the presentations.

35. The method of claim 32, wherein selecting and organizing the presentations are automatically updated as the user's access patterns change.

36. The method of claim 35, further comprising removing presentations that are no longer considered relevant to the user.

37. The method of claim 32, wherein the presentations may be at least one of visual presentations, web pages, audio presentations, tactile presentations, and any other type of presentations.

38. A method of managing data, the method comprising:
monitoring presentations previously recorded by a user for later access;
automatically selecting some of the user-recorded presentations accessed by the user according to the user's access patterns; and
organizing the selected presentations to reflect their relevance to the user.

39. A method of managing data, the method comprising:
monitoring a user's access patterns of presentations recorded by the user as bookmarked presentations; and
organizing the bookmarked presentations according to the user's access patterns of bookmarked presentations.

40. The method of claim 39, wherein a presentation is automatically selected according to the user's access patterns comprising at least one of:
frequency of user's access;
recency of user's access;
amount of time spent by the user on the presentation;
amount of user activity performed on the presentation;
recording by the user of the presentation in a favorite list; and
marking of the presentation for Snapback by the user.

41. The method of claim 39, wherein selecting presentations and organizing the selected presentations are automatically updated as the user's access patterns change.

42. The method of claim 39, further comprising removing presentations that are no longer considered relevant to the user.

43. The method of claim 39, wherein the presentations may be at least one of visual presentations, web pages, audio presentations, tactile presentations, and any other type of presentations.

44. A method of managing data, the method comprising:
marking a recorded presentation as temporary;
assigning an expiration date to the presentation; and
removing the presentation at the expiration date.

45. A method of managing data, the method comprising:
marking a recorded presentation as temporary;
specifying removal criteria for the presentation; and
removing the presentation when the removal criteria are met.

46. A method as in claim 45 wherein marking the presentation is performed in response to a user input.

47. The method of claim 45, wherein removing the presentation is performed automatically.

48. The method of claim 45, wherein the presentation may be at least one of a visual presentation, web page, audio presentation, tactile presentation, and any other type of presentation.

49. A method of managing data, the method comprising:
attempting to access a presentation recorded by a user;
presenting the user with the option to remove the presentation if the presentation can no longer be accessed; and
removing the presentation if the user elects to do so.

50. A method as in claim 49 wherein attempting to access the presentation is performed in response to an input by the user.

51. A method as in claim 49 wherein attempting to access the presentation is performed automatically.

52. A method of managing data, the method comprising:
attempting to access all presentations in a list; and
removing presentations from the list that can no longer be accessed.

53. The method of claim 52, wherein removing presentations from the list that can no longer be accessed is performed automatically.

54. The method of claim 52, wherein removing presentations from the list is performed in response to a user input.

55. The method of claim 52, wherein the presentations may be at least one of visual presentations, web pages, audio presentations, tactile presentations, and any other type of presentations.

56. A data processing system comprising:
means for monitoring presentations accessed by a user;
means for automatically selecting some of the presentations accessed by the user according to the user's access patterns; and
means for organizing the selected presentations to reflect their relevance to the user.

57. A data processing system comprising:
means for monitoring presentations previously recorded by a user for later access;
means for automatically selecting some of the user-recorded presentations accessed by the user according to the user's access patterns; and
means for organizing the selected presentations to reflect their relevance to the user.

58. A data processing system comprising:
means for monitoring a user's access patterns of presentations recorded by the user as bookmarked presentations; and
means for organizing the bookmarked presentations according to the user's access patterns of bookmarked presentations.

59. A data processing system comprising:
means for marking a recorded presentation as temporary;
means for assigning an expiration date to the presentation; and
means for removing the presentation at the expiration date.

60. A data processing system comprising:
means for marking a recorded presentation as temporary;
means for specifying removal criteria for the presentation; and
means for removing the presentation when the removal criteria are met.

61. A data processing system comprising:
means for attempting to access a presentation recorded by a user;
means for presenting the user with the option to remove the presentation if the presentation means for can no longer be accessed; and
means for removing the presentation if the user elects to do so.

62. A data processing system comprising:
means for attempting to access all presentations in a list; and
means for removing presentations from the list that can no longer be accessed.
